(19) United States
(12) Patent Application Publication
(10) Pub. No.: US 2017/0236112 A1
(43) Pub. Date: Aug. 17, 2017

(54) METHOD, NON-TRANSITORY COMPUTER-READABLE MEDIUM AND SYSTEM FOR COMPUTER-BASED CROWDFUNDING

(71) Applicant: Gustavo Arguello, Houston, TX (US)

(72) Inventor: Gustavo Arguello, Houston, TX (US)

(21) Appl. No.: 15/043,914

(22) Filed: Feb. 15, 2016

(51) Int. Cl. G06Q 20/22

(52) U.S. Cl. CPC G06Q 20/22; G06Q 50/01

(57) ABSTRACT

Computer-based crowdfunding may provide network communication between at least one user device, a funding module, and a timing module over at least one network. Data from the at least one user device, the funding module, and the timing module may be processed by at least one processor, sent to at least one server, and stored in at least one data repository. The funding module and timing module may interact with each other and/or the network in real-time over a first time period, a second time period, and a third period. After the time periods elapse, funds received in the funding module from supporters may be transferred to competitors and/or returned to supporters over the network.

### FIELD OF THE DISCLOSURE

The present disclosure generally relates to computer-based crowdfunding. In particular, the disclosure relates to computer-based crowdfunding in real-time over first, second, and third time periods.

### BACKGROUND

Crowdfunding, particularly for student athletes, can present many challenges, as compensation for playing a sport cannot be provided to student athletes, according to the National Collegiate Athletic Association (NCAA). Regarding individuals and groups who desire to make financial contributions to student athletes, conventional crowdfunding does not provide a complete computer-based method and system to process crowdfunding data. Further, conventional crowdfunding does not provide a platform for making financial contributions that can later be distributed to student athletes, after they are no longer students, and that allows individuals and groups to designate to which team an athlete can join as a condition for accepting a financial contribution. Thus, athletes can face detrimental consequences for accepting funds prior to an eligible time period.

### SUMMARY

Embodiments of the present disclosure may provide a method for computer-based crowdfunding. The method may include establishing communication over a network with at least one user device, with a funding module that may receive funds in at least one account from at least one supporter, and with a timing module that may provide, in real-time, a first time period, a second time period, and a third time period. The method may include processing data that may be received from the at least one user device, the funding module, and the timing module, and processing may performed using at least one processor that may transmit the data to at least one server. The method may provide that the at least one server may transmit the data to at least one data repository. The method may include storing the data in the at least one data repository, and the method may provide that the at least one data repository may have a plurality of databases that may operate in-real time according to the first time period, the second time period, and the third time period that may be provided by the timing module. The method may include transmitting closing instructions to the funding module after the first time period elapses, wherein additional funds may not be received in the funding module. Additionally, the method may include receiving a first input from a competitor after the first time period elapses. The method may include receiving a second input from the competitor after the second time period elapses. The method may include transmitting winning account instructions to the funding module. A winning account may be identified from a plurality of accounts in the funding module, the winning account having a greatest amount of funds. The method may provide that the plurality of accounts other than the winning account may be non-winning accounts. The method may include transmitting first return instructions to the funding module to return returnable funds that may be held in the non-winning accounts to the at least one supporter. The method may include transmitting second return instructions to the funding module to return funds in the winning account to the at least one supporter. The second return instructions may be transmitted when a competitor may fail to provide a first input that may indicate a first agreement by the competitor to join an organization. The method may further provide that a second input may indicate a second agreement by the competitor to accept the funds from the winning account. The method may include transmitting acceptance instructions to the funding module to transfer the funds in the winning account to a competitor after the third time period elapses.

Embodiments of the present disclosure may provide a non-transitory computer-readable medium for performing a method of computer-based crowdfunding. The method may include, over a network, receiving data that may be provided from at least one user device, a funding module that may be provided to transfer funds held in at least one account to at least one of a competitor and a supporter, and a timing module that may be provided to determine when the funds may be transferred based on a first time period, a second time period, and a third time period. The steps may further include, using at least one processor, processing the data that may be provided from the at least one user device, the funding module, and the timing module. The method may include sending at least one signal to the funding module to initiate closing the at least one account after the first time period elapses, wherein additional funds cannot be received in the funding module. Further, the method may include receiving a first input from the competitor after the first time period elapses. The method may include receiving a second input from the competitor after the second time period elapses. The method may include, using the at least one processor, determining a winning account that may be identified from a plurality of accounts in the funding module. The winning account may have a greatest amount of funds, and the method may provide that the plurality of accounts other than the winning account may be non-winning accounts. The method may include returning, via the network to the at least one supporter, returnable funds that may be held in the non-winning accounts. The method may include returning, via the network, to the at least one supporter funds that may be held in the winning account. The method may provide that the funds held in the winning account may be returned to the at least one supporter when the competitor may fail to provide a first input that may indicate a first agreement by the competitor to join an organization and a second input that may indicate a second agreement by the competitor to accept the funds from the winning account. The method may include transferring, via the network, to the at least one user device of the competitor funds that may be in the winning account after the third time period elapses.

Embodiments of the present disclosure may provide a computer-based crowdfunding system that may include a network that may be in communication with a funding module configured to receive funds from at least one supporter, a timing module that may be configured to provide, in real-time, a first time period, a second time period, and a third time period, and at least one user device. The system may include at least one processor that may be in communication with the network and configured to transmit data from the funding module, the timing module, and the at least one user device to at least one server. The at least one server may be configured to transmit the data to at least one data repository. The system may include a plurality of databases that may be provided in the at least one data repository. The plurality of databases may be configured to store the data in real-time that may be based on the first time period, the second time period, and the third time period. The timing module may be configured to communicate with the funding module after the first time period elapses, after the second time period elapses, and after the third time period elapses. The funding module may be configured to close an account that may have the funds and may decline acceptance of additional funds after the first time period elapses. The funding module may be configured to determine a winning account that may have a greatest amount of funds after the second time period elapses. The funding module may be configured to transfer the greatest amount of funds to at least one competitor or the at least one supporter after the third time period elapses. The funding module may be configured to determine non-winning accounts as the plurality of accounts other than the winning account. The funding module may be configured to return funds that may be held in the non-winning accounts, via the network, to the at least one supporter that may correspond to each non-winning account. The funding module may be configured to transfer, via the network, funds that may be held in one or more additional winning accounts to one or more additional competitors.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 depicts a graphical user interface according to an embodiment of the present disclosure;

FIG. 2 depicts a crowdfunding platform according to an embodiment of the present disclosure;

FIG. 3 depicts a funding module according to an embodiment of the present disclosure; and

FIG. 4 depicts a timing module according to an embodiment of the present disclosure.

### DETAILED DESCRIPTION

Embodiments of the present disclosure may generally provide a method, a non-transitory computer-readable medium, and a system for computer-based crowdfunding. The method, non-transitory computer-readable medium, and system may provide a timing module that may detect when a plurality of time periods have elapsed in real-time, and a funding module that may transfer funds to a user after the plurality of time periods have elapsed.

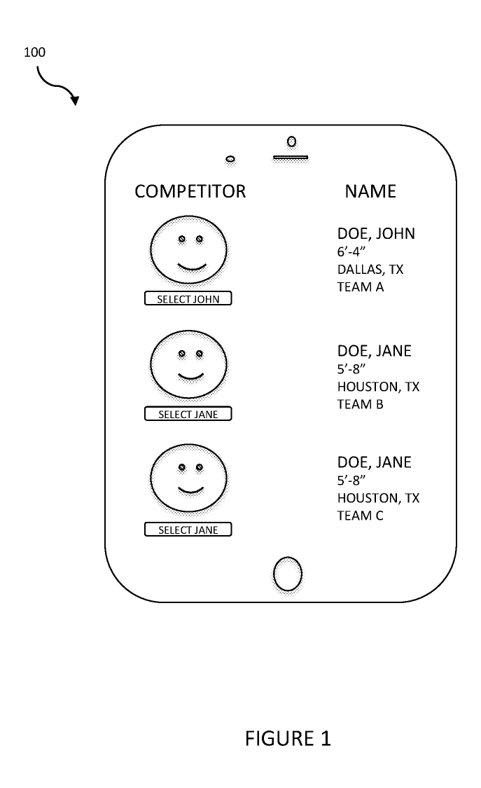

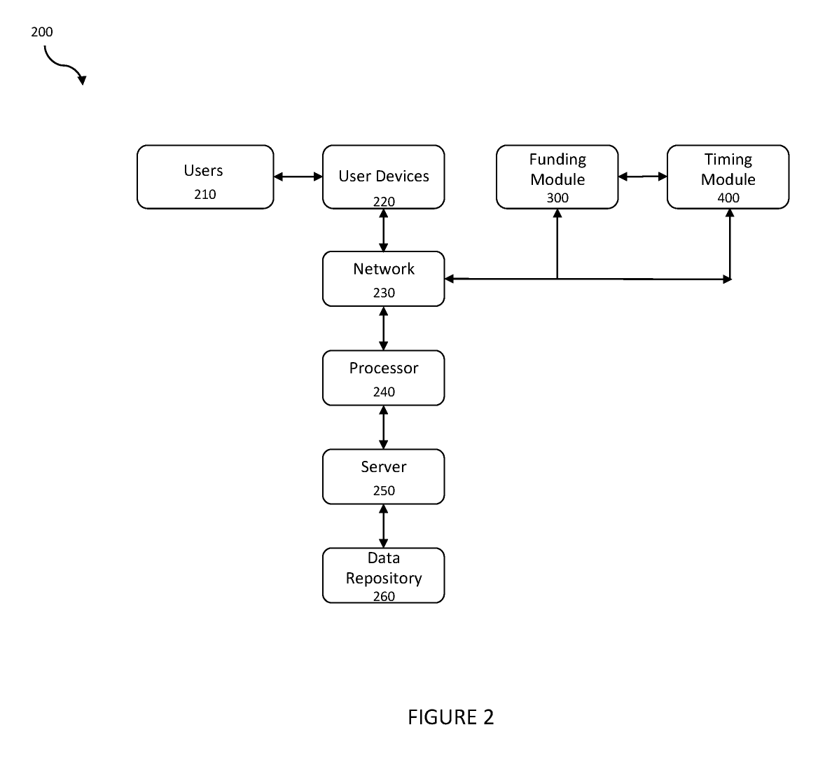

As shown in FIG. 1 according to an embodiment of the present disclosure, a method, a non-transitory computer-readable medium, and a system for computer-based crowdfunding (hereinafter, “computer-based crowdfunding”) may provide graphical user interface (GUI) 100. Information that may identify and correspond to at least one competitor may be displayed in GUI 100 and may be selected by at least one supporter. Information that may identify and correspond to at least one competitor may include, but is not limited to, name, geographic location, and height. It should be appreciated that the at least one competitor, the at least one supporter, and an organization (i.e., including, but not limited to, a team and an association) may be referred to as users 210 (FIG. 2) of the computer-based crowdfunding. It should be appreciated that user devices 220 (FIG. 2) may include, but are not limited to, smart phones, laptop computers, personal computers, and tablets. It should be appreciated that at least one competitor and at least one supporter are required in order for the method and the non-transitory computer-readable medium for computer-based crowdfunding to operate.

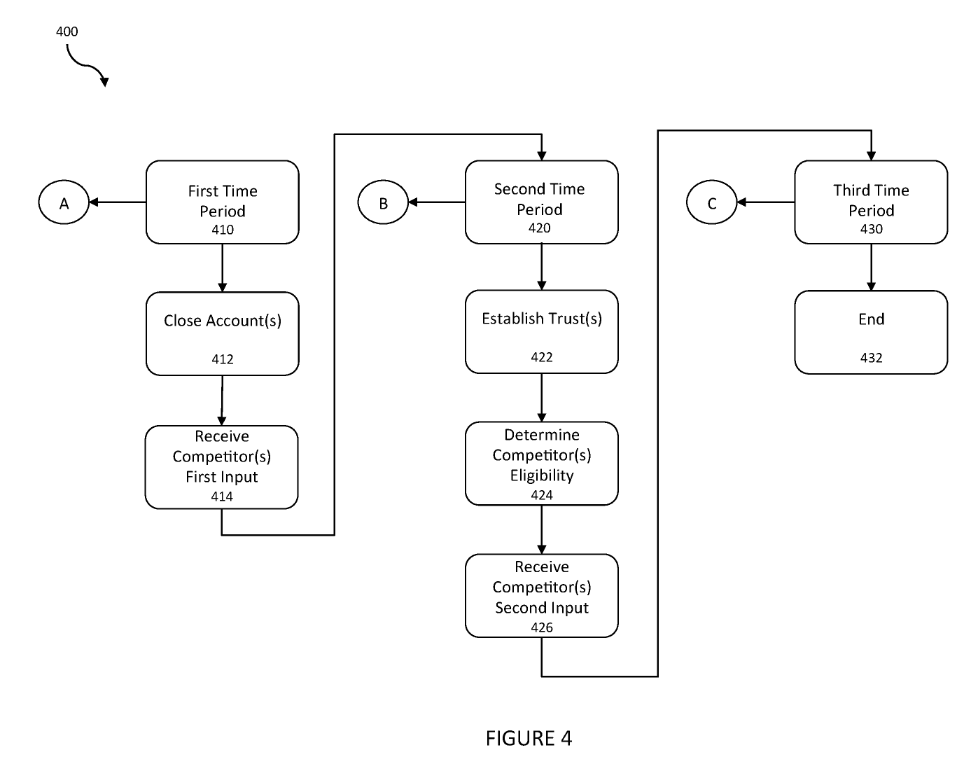

As shown in FIG. 2 according to an embodiment of the present disclosure, computer-based crowdfunding may occur using crowdfunding platform 200 that may include at least one user device 220 in which at least one user 210 may utilize at least one user device 220 to perform computer-based crowdfunding. Crowdfunding platform may further provide at least one network 230, at least one processor 240, at least one server 250, at least one data repository 260, funding module 300, and timing module 400. At least one network 230 may connect at least one user device 220 to at least one processor 240, and may connect funding module 300 and timing module 400 to at least one processor 240. Data received from at least one user device 220, funding module 300, and timing module 400 may be processed by at least one processor 240. Further, at least one processor 240 may transmit the data to at least one server 250 on which the data may be available to the at least one user 210. At least one data repository 260 may store data in real-time provided by at least one server 250. It should be appreciated that the data may include data received from at least one user device 220, funding module 300, and/or timing module 400. It should be appreciated that at least one data repository 260 may process data in real-time according to first time period 410, second time period 420, and third time period 430 (FIG. 4).

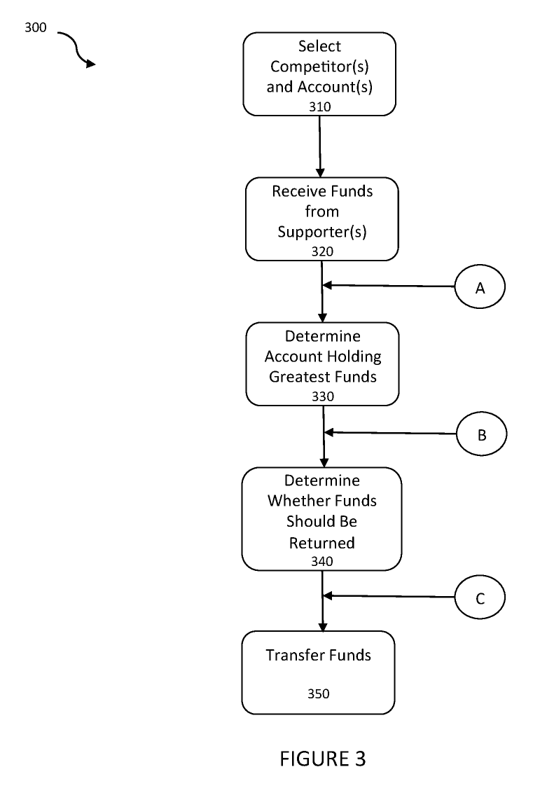

As shown in FIG. 3 according to an embodiment of the present disclosure, computer-based crowdfunding may provide funding module 300 that may ultimately transfer funds to at least one user 210. Funding module 300 may allow at least one supporter to select at least one competitor that may correspond to at least one account (step 310) from GUI 100. It should be appreciated that the at least one account may be an athletic organization account. For example, a supporter (i.e., a sports fan) may select a competitor (i.e., John Doe, football player) and an account (i.e., Team A) from GUI 100 because the supporter may desire for John Doe to be recruited by and play for Team A. It should be appreciated that funds contributed by supporters may influence a decision of a competitor and/or an organization regarding whether the competitor may join the organization. It should further be appreciated that a competitor and/or an organization may receive funds in an account. It should also be appreciated that supporters may play an active managerial role in steering the competitor to or from a particular organization. Funding module 300 may allow the at least one supporter to contribute funds to the at least one account, and the at least one competitor may later receive the funds from the at least one supporter (step 320).

It should be appreciated that “A”, as shown in FIGS. 3 and 4, corresponds to first time period 410 (FIG. 4) in which the at least one account closes and additional funds may no longer be received via funding module 300. It should be appreciated that first time period 410 (FIG. 4) may be predetermined in some embodiments of the present disclosure.

Funding module 300 may determine which account from a plurality of accounts may hold funds that may total a greatest amount compared to funding amounts that may be provided in other accounts (step 330). It should be appreciated that the account holding a funding amount greater than the other accounts may be considered a winning account, and the at least one competitor corresponding to the winning account may ultimately receive the funds in exchange for joining the organization to which the winning account corresponds. It should be appreciated that network 230 may transmit a set of winning account instructions to funding module and/or timing module in order to determine the account that may hold the greatest amount of funds compared to other accounts. For example, a competitor may have an account with Team A, Team B, and Team C, and the Team A account may hold the greatest amount of funds compared to the Team B and Team C accounts; thus, Team A may be considered a winning account, and the at least one competitor may receive funds from the Team A account.

It should be appreciated that “B”, as shown in FIGS. 3 and 4, corresponds to second time period 420 (FIG. 4) in which timing module 400 may have received first input 414 from the at least one competitor. It should be appreciated that second time period 420 (FIG. 4) may be predetermined in some embodiments of the present disclosure. It should further be appreciated that first input 414 may be required in order for the at least one competitor to receive funds.

Funding module 300 may determine whether funds should be returned to the at least one supporter (step 340). All accounts that are not the winning account may be designated as non-winning accounts, and funds in non-winning accounts that are eligible to be returned may be returned to supporters. It should be appreciated that network 230 may transmit a set of first return instructions to funding module in order to return funds in non-winning accounts to supporters. For example, a competitor may have an account with Team A, Team B, and Team C, and the Team A account may hold the greatest amount of funds, thereby constituting a winning account. Team B and C accounts may then be considered non-winning accounts and funds from the non-winning accounts that are eligible to be returned may be returned to supporters.

It should be appreciated that funds in a winning account also may be returned to supporters when the at least one competitor does not join an organization to which a winning account corresponds. It should be appreciated that network 230 may transmit a set of second return instructions to funding module in order to return funds in winning accounts to supporters. For example, a competitor may have an account with Team A, Team B, and Team C. The Team A account may hold the greatest amount of funds (i.e., is a winning account), but the competitor may decide not to join Team A; thus, winning funds in the Team A account may be returned to supporters and may not be transferred to the competitor.

It should be appreciated that “C”, as shown in FIGS. 3 and 4, corresponds to third time period 430 (FIG. 4) in which funds may be transferred to the at least one competitor (step 350). It should be appreciated that first, second, and third time periods 410, 420, and 430 (“A”, “B”, and “C”), respectively, must elapse before funds may be transferred to the at least one competitor.

As shown in FIG. 4 according to an embodiment of the present disclosure, computer-based crowdfunding in real-time may utilize timing module 400 that may provide first, second, and third time periods 410, 420, and 430. Timing module 400 may provide first time period 410 (“A”) that may be a time period before an account will close and no longer accept funds from supporters (step 412). It should be appreciated that network 230 may transmit a set of account closing instructions to funding module to refuse acceptance of additional funds. It should be appreciated that the time when the account will close and no longer accept funds from supporters may be predetermined (i.e., Tuesday, Mar. 2, 2021 at 6 PM EST) in some embodiments of the present disclosure.

After closing an account (step 412), timing module 400 may receive a first input from the at least one competitor (step 414). It should be appreciated that the first input may be received by timing module 400, and in an embodiment of the present disclosure, the first input may be a competitor's first agreement/commitment to join the organization corresponding to an account. Having that first agreement/commitment, the competitor may later accept funds from the account corresponding to the organization. It should be appreciated that funds in a winning account may be returned to supporters when the at least one competitor fails to provide a first input. It should be appreciated that the first input may be required in order for the at least one competitor to provide a second input in some embodiments of the present disclosure, as further described below. It should be appreciated that the first input may be received using a computer and/or a computer-based device.

Timing module 400 may further provide second time period 420 (“B”) that may be a time period between when an account closes when a first input may be received from the at least one competitor. After second time period 420 elapses, timing module 400 may establish at least one trust (step 422) that may include funds received from a supporter. The at least one trust could be a unique combination of a specific competitor signing with a specific organization in an embodiment of the present disclosure. Timing module 400 may determine whether the at least one competitor may be eligible to receive funds from at least one trust (step 424) by performing a computer-based analysis to verify the competitor's eligibility status. As with first time period 410, second time period 420 may be predetermined in some embodiments of the present disclosure.

After determining whether the at least one competitor may be eligible to receive funds from a trust (step 424), timing module 400 may receive a second input associated with the at least one competitor (step 426). It should be appreciated that receiving a second input may be a trigger condition that may entitle a competitor and/or an organization to receive funds that may be held in an account. It should be appreciated that the second input may be a competitor's second agreement/commitment to accept funds from an account in exchange for joining the organization corresponding to the account. Having that second agreement/commitment, the competitor may later receive funds from the account corresponding to the organization. It should be appreciated that the second input may be required in order for the at least one competitor to receive funds in some embodiments of the present disclosure. It should further be appreciated that funds in a winning account may be returned to supporters when the at least one competitor fails to provide a second input. It should further be appreciated that the second input may be received using a computer and/or a computer-based device.

Timing module 400 may provide third time period 430 (“C”) that may be a time period between receiving the second input from the at least one competitor (step 426) and transferring funds to the at least one competitor or ending computer-based crowdfunding (step 432). It should be appreciated that third time period 430 may be predetermined in some embodiments of the present disclosure. It should be appreciated that timing module 400 may provide any number of time periods. It should be appreciated that network 230 may transmit a set of acceptance instructions to funding module to transfer funds to the at least one competitor.

It should be appreciated that a method and a non-transitory computer-readable medium for computer-based crowdfunding according to embodiments of the present disclosure may be implemented using a computer and/or a computer-based device. The method and non-transitory computer-readable medium may provide advantages over conventional computer-based crowdfunding including, but not limited to, managing communication between a plurality of competitors and supporters in real-time. It should be appreciated that a method for computer-based crowdfunding according to embodiments of the present disclosure may connect any number of competitors and/or supporters without departing from the present disclosure. It should further be appreciated that funds associated with one or more winning accounts, in addition to funds in the winning account, may be transferred to one or more additional competitors without departing from the present disclosure. It should be appreciated that computer-based crowdfunding may provide transparency to supporters, competitors, and organizations. It should further be appreciated that this transparency may include access to view accounts and/or status updates regarding when a trigger condition may be expected to occur. It should be appreciated that a trigger condition may entitle a competitor and/or an organization to automatically receive funds that may be held in an account. It should be appreciated that a competitor may automatically receive funds when the competitor acquires an eligible status without departing from the present disclosure. It should further be appreciated that an eligible status may be based on the competitor acquiring a non-student status without departing from the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for computer-based crowdfunding, the method comprising:
establishing communication over a network with at least one user device, with a funding module that receives funds in at least one account from at least one supporter, and with a timing module that provides, in real-time, a first time period, a second time period, and a third time period;
processing data received from the at least one user device, the funding module, and the timing module using at least one processor that transmits the data to at least one server, wherein the at least one server transmits the data to at least one data repository; and
storing the data in the at least one data repository, the at least one data repository having a plurality of databases operating in-real time according to the first time period, the second time period, and the third time period provided by the timing module.

2. The method for computer-based crowdfunding of claim 1 further comprising:
transmitting closing instructions to the funding module after the first time period elapses, wherein additional funds cannot be received in the funding module; and
receiving a first input from a competitor after the first time period elapses.

3. The method for computer-based crowdfunding of claim 2 further comprising:
receiving a second input from the competitor after the second time period elapses.

4. The method for computer-based crowdfunding of claim 1 further comprising:
transmitting winning account instructions to the funding module,
wherein a winning account is identified from a plurality of accounts in the funding module, the winning account having a greatest amount of funds, and
wherein the plurality of accounts other than the winning account are non-winning accounts.

5. The method for computer-based crowdfunding of claim 4 further comprising:
transmitting first return instructions to the funding module to return returnable funds held in the non-winning accounts to the at least one supporter.

6. The method for computer-based crowdfunding of claim 4 further comprising:
transmitting second return instructions to the funding module to return funds in the winning account to the at least one supporter, the second return instructions being transmitted when a competitor fails to provide a first input indicating a first agreement by the competitor to join an organization and a second input indicating a second agreement by the competitor to accept the funds from the winning account

7. The method for computer-based crowdfunding of claim 4 further comprising:
transmitting acceptance instructions to the funding module to transfer the funds in the winning account to a competitor after the third time period elapses.

8. A non-transitory computer-readable medium for performing a method of computer-based crowdfunding, the method comprising the steps of:
over a network, receiving data provided from at least one user device, a funding module provided to transfer funds held in at least one account to at least one of a competitor and a supporter, and a timing module provided to determine when the funds will be transferred based on a first time period, a second time period, and a third time period; and
using at least one processor, processing the data provided from the at least one user device, the funding module, and the timing module.

9. The method of claim 8, the method further comprising:
sending at least one signal to the funding module to initiate closing the at least one account after the first time period elapses, wherein additional funds cannot be received in the funding module; and
receiving a first input from the competitor after the first time period elapses.

10. The method of claim 9 further comprising:
receiving a second input from the competitor after the second time period elapses.

11. The method of claim 8, further comprising:
using the at least one processor, determining a winning account identified from a plurality of accounts in the funding module, the winning account having a greatest amount of funds,
wherein the plurality of accounts other than the winning account are non-winning accounts.

12. The method of claim 11, further comprising:
returning, via the network, to the at least one supporter returnable funds held in the non-winning accounts.

13. The method of claim 11, further comprising:
returning, via the network, to the at least one supporter funds held in the winning account, when the competitor fails to provide a first input indicating a first agreement by the competitor to join an organization and a second input indicating a second agreement by the competitor to accept the funds from the winning account.

14. The method of claim 11, further comprising:
transferring, via the network, to the at least one user device of the competitor funds in the winning account after the third time period elapses.

15. A computer-based crowdfunding system, comprising:
a network in communication with a funding module configured to receive funds from at least one supporter, a timing module configured to provide, in real-time, a first time period, a second time period, and a third time period, and at least one user device;
at least one processor in communication with the network, wherein the at least one processor is configured to transmit data from the funding module, the timing module, and the at least one user device to at least one server, wherein the at least one server is configured to transmit the data to at least one data repository; and
a plurality of databases provided in the at least one data repository, the plurality of databases configured to store the data in real-time based on the first time period, the second time period, and the third time period.

16. The computer-based crowdfunding system of claim 15, wherein the timing module is configured to communicate with the funding module after the first time period elapses, after the second time period elapses, and after the third time period elapses.

17. The computer-based crowdfunding system of claim 15,
wherein the funding module is configured to close an account having the funds and decline acceptance of additional funds after the first time period elapses,
wherein the funding module is configured to determine a winning account having a greatest amount of funds after the second time period elapses, and
wherein the funding module is configured to transfer the greatest amount of funds to at least one competitor or the at least one supporter after the third time period elapses.

18. The computer-based crowdfunding system of claim 17, wherein the funding module is configured to determine non-winning accounts as the plurality of accounts other than the winning account.

19. The computer-based crowdfunding system of claim 18, wherein the funding module is configured to return funds held in the non-winning accounts, via the network, to the at least one supporter that corresponds to each non-winning account.

20. The computer-based crowdfunding system of claim 17, wherein the funding module is configured to transfer, via the network, funds held in one or more additional winning accounts to one or more additional competitors.
